(19) United States
(12) Patent Application Publication
(10) Pub. No.: US 2006/0060414 A1
(43) Pub. Date: Mar. 23, 2006

(54) Electric power steering system

(75) Inventors: Yoshikazu Kuroumaru, Nara (JP); Shirou Nakano, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Koyo Seiko Co., Ltd., Osaka (JP)

(21) Appl. No.: 11/229,666

(22) Filed: Sep. 20, 2005

(30) Foreign Application Priority Data
Sep. 21, 2004 (JP) P 2004-273501

(51) Int. Cl. B62D 5/04

(52) U.S. Cl. 180/444

(57) ABSTRACT

An electric power steering system which assists in steering by driving an electric motor in accordance with an operation of a steering member, comprising a drive gear connected to a rotation shaft of the electric motor and a driven gear securely fitted on a steering shaft so as to mesh with the drive gear, wherein the driven gear includes a gear body and a ring element that is mounted on the gear body in such a manner as to slide relative to the gear body.

### BACKGROUND OF THE INVENTION

The present invention relates to an electric power steering system which assists a driver in steering by driving an electric motor in accordance with an operation by the driver of a steering member such as a steering wheel.

The electric power steering system includes a torque sensor for detecting a steering torque of the steering wheel applied by the driver, the electric motor which assists in steering effort, a speed reduction mechanism which reduces the rotational speed of the electric-motor for transmission to a steering shaft and an electronic control unit (ECU) which controls the electric motor based on sensor signals such as from the torque sensor.

The speed reduction mechanism is made up of a drive gear such as a worm gear connected to a rotation shaft of the electric motor and a driven gear such as a worm wheel securely fitted on the steering shaft and gives a sum of a steering torque that is applied by the operation of the steering wheel by the driver and a steering assist torque that is generated by the electric motor to a steering mechanism as an output torque.

In the electric power steering system that is configured as has been described above, noise is generated at the time of steering when the vehicle is running on a road whose surface is rough or has irregularities, whereby the steering feel and the quietness in the passenger compartment are badly affected. The inventor of this invention studied about causes for the noise to find that gear teeth striking noise was a root cause of the noise that was generated by and attributed to a backlash between the drive and driven gearwheels of the speed reduction mechanism due to both the drive and driven gearwheels being made of a steel material.

As to the suppression of the gear teeth striking noise generated between both the drive and driven gears of the reduction mechanism, there has been proposed, for example, an electric power steering system in which a worn wheel, which constitutes a driven gear, is made up of first and second gears having the same number of teeth and the same pitch which are aligned in an axial direction on an outer circumference of a hub concentrically and in such a manner as to be torsionally displaced, and an elastic element which connects the first and second gears to each other in such a manner that phases of teeth of the first and second gears become elastic relative to the hub, so that the teeth of the first and second gears hold teeth of a worm gear therebetween from both circumferential sides at a meshing point (refer to Patent Document No. 1). In the related art electric power steering mechanism, according to what is described in the specification, it is understood that the transmission of vibrations via the meshed portions of the teeth of the first and second gears is absorbed by the elastic element and the backlash of the meshed portions is eliminated, whereby the generation of gear teeth striking noise is effectively prevented.

However, the elastic element repeats its compression and restoration such that the elastic element is elastically compressed at the position of the meshed portions of the first and second gears, whereas the elastic element is elastically restored at positions other than the meshed portions, whereby the elastic element is worn and fatigued earlier, triggering a risk that the gear teeth striking noise eliminating or preventing effect may be deteriorated earlier.

Furthermore, it is not easy from the view point of design to set the thickness of the elastic element that is to reside between the first and second gears and the hub, to set the hardness of the elastic element or to select a material for the elastic material with a view to obtaining the vibration suppressing effect. In addition, it is difficult to install the elastic element between the first and second gear and the hub and hence it is difficult to manufacture the relevant electric power steering system, and the configuration thereof is such as to be difficult to attain the originally intended effect.

Patent Document No. 1: JP-A-2001-355700

### SUMMARY OF THE INVENTION

Consequently, a problem that the invention is to solve is to enable a stable and long-lasting reduction of gear teeth striking noise and meshing slide noise between the drive and driven gears by a simple construction having a superior fabricating characteristic in place of the aforesaid elastic element.

In order to solve the aforesaid object, the invention is characterized by having the following arrangement.

(1) An electric power steering system which assists in steering by driving an electric motor in accordance with an operation of a steering member, comprising:

a drive gear connected to a rotation shaft of the electric motor; and

a driven gear securely fitted on a steering shaft so as to mesh with the drive gear;

wherein the driven gear includes a gear body and a ring element that is mounted on the gear body in such a manner as to slide relative to the gear body.

(2) The electric power steering system according to (1), wherein the ring element is slidable in a circumferential direction of the gear body.

(3) The electric power steering system according to (2), wherein the gear body is provided with an annular groove on which the ring element is arranged.

(4) The electric power steering system according to (3), wherein the ring element is fitted to the annular groove by a transition fit.

(5) The electric power steering system according to (1), wherein the ring element is slidable in an axial direction of the gear body.

(6) The electric power steering system according to (1), wherein a pair of the ring elements are arranged at opposite sides of the gear body.

(7) The electric power steering system according to (1), wherein the gear body is made of steel or resin, and the ring element is made of steel.

(8) The electric power steering system according to (1), wherein the gear body is provided with a toothed portion at an outer circumference thereof.

(9) The electric power steering system according to (1), wherein the ring element is arranged at one of axial sides of the gear body.

According to the electric power steering system, since the ring element that is mounted on the gear body is made to slide relative to the gear body, in the event that gear teeth striking noise and meshing slide noise are generated between the drive gear and the driven gear, while the gear body vibrates due to an impact generated by the striking of the teeth and meshing slide, the vibration of the gear body is attenuated at an early stage by the ring element.

As a result, according to the invention, being different from the elastic element of the related art, gear teeth striking noise and meshing slide noise generated between the drive gear and the driven gear can be reduced effectively with the simple configuration resulting by mounting the ring element on the gear body, whereby the electric power steering system of the invention can contribute to improving the steering feel of the vehicle and realizing quietness in the passenger compartment

According to the invention, in the electric power steering system, gear teeth striking noise between the drive gear on the electric motor side and the driven gear on the steering shaft side can effectively be reduced or suppressed in the different manner from that of the related art in which the elastic element is used.

### BRIEF DESCRIPTION OF THE DRAWINGS

FIG. 1 is a sectional view of a speed reduction mechanism portion of an electric power steering system according to a first embodiment of the invention.

FIG. 2 is an enlarged front view of a driven gear in the electric power steering system shown in FIG. 1.

FIG. 3 is a sectional view taken along the line III-III in FIG. 2.

FIG. 4 is an enlarged front view of a driven gear in an electric power steering system according to a second embodiment of the invention.

FIG. 5 is a sectional view taken along the line V-V in FIG. 4.

FIG. 6 is an enlarged front view showing another modified example of a driven gear.

### DETAILED DESCRIPTION OF PREFERRED EMBODIMENTS

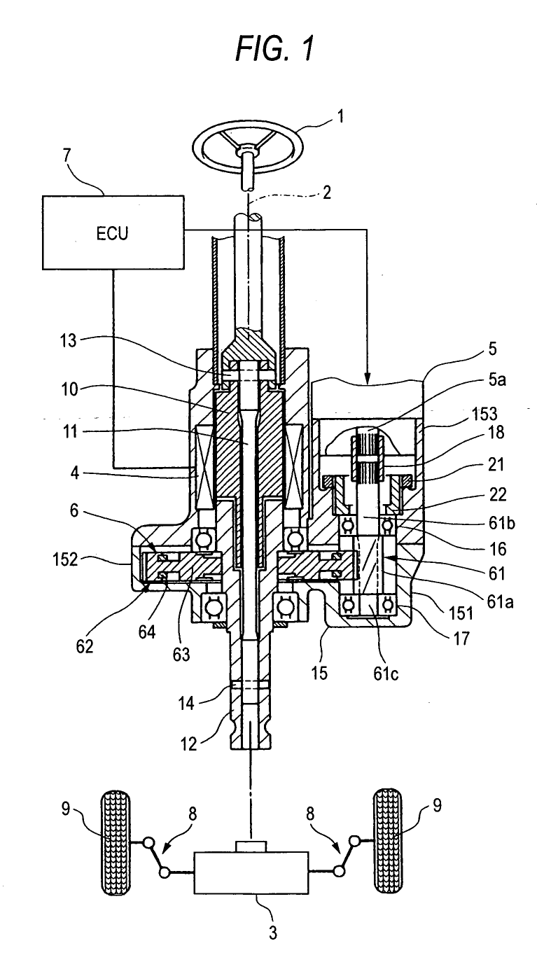

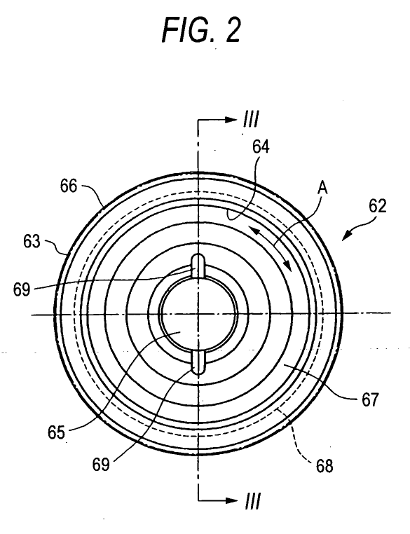

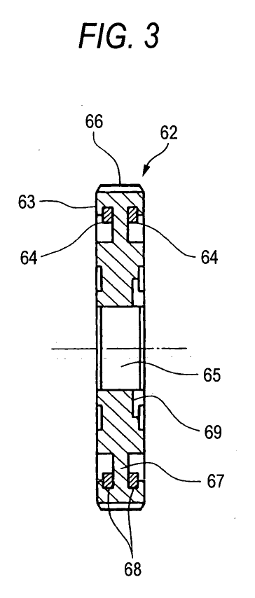

An electric power steering system according to a first embodiment of the invention will be described in detail by reference to the accompanying drawing. FIG. 1 is a sectional view of a speed reduction mechanism portion of the electric power steering system in which related configurations are also shown. FIG. 2 is a front view of a driven gear, and FIG. 3 is a sectional view taken along the line III-III in FIG. 2.

The electric power steering system according to the first embodiment includes a steering shaft 2 which is connected to a steering member (a steering wheel) 1 at one end thereof, a steering mechanism 3 made up of a rack-and-pinion mechanism which is connected to the other end of the steering shaft 2, a torque sensor for detecting a steering torque that is applied to the steering shaft 2 through an operation of the steering member 1, an electric motor 5 which generates a steering assist torque for reducing a load borne by a driver when he or she operates the steering member 1, a speed reduction mechanism 6 which transmits a steering assist torque generated by the electric motor 5 to the steering shaft 2 and an electronic control unit (ECU) 7 which controls the drive of the electric motor 5 based on sensor signals from the torque sensor 4 and the like.

In a vehicle on which the electric power steering system is installed, when the driver operates the steering member 1, a steering torque generated through the operation by the driver is detected by the torque sensor 4. The electronic control unit 7 controls the drive of the electric motor 5 based on information on the steering torque so detected, whereby the electric motor 5 generates a steering assist torque, and the steering assist torque so generated is applied to the steering shaft 2 via the speed reduction mechanism 6, a load that is borne by the driver when he or she operates the steering member 1 being thereby reduced. Namely, a sum of the steering torque that is applied by the operation of the steering member 1 and the steering assist torque generated by the electric motor 5 is applied to the steering mechanism 3 via the steering shaft 2 as an output torque.

From this, an input shaft of the steering mechanism 3 is rotated, and the rotation is transformed into a reciprocating motion of a rack shaft which is an output shaft by the steering mechanism 3. Opposite ends of the rack shaft are connected to steering road wheels 9 via connecting members 8 which are each made up of a tie rod and a knuckle arm, whereby the direction of the road wheels 9 changes in accordance with the reciprocating motion of the rack shaft.

In the electric power steering system, a middle portion of the steering shaft 2 is made up of a tubular input shaft 10, a torsion bar 11 and a tubular output shaft 12. The input shaft 10 is connected to the torsion bar 11 that is inserted into a tubular interior thereof with a pin 13 that penetrates therethrough diametrically, and upper end portions of the input shaft 10 and the torsion bar 11 are connected to a lower end portion of a shaft which makes up an upper portion of the steering shaft 2. The torsion bar 11 is such as to have an elongated and thin torsional area at a middle portion thereof, and as has been described above, the large-diameter upper end portion is connected to the input shaft 10 with the pin 13, and a similar large-diameter lower end portion is inserted into a tubular interior of the output shaft 12 so as to be connected to the output shaft 12 with a pin 14 which penetrates therethrough diametrically. The input shaft 10 and the output shaft 12 extend over an outer circumference of the torsion bar 11 towards the lower end side and the upper end side of the torsion bar 11, respectively, in such a manner that the respective extending portions axially face each other at the middle portion on the outer circumference of the torsion bar 11. The torque sensor 4 is arranged at the portion on the outer circumference of the torsion bar 11 where the input shaft 10 and the output shaft 12 face each other axially.

The speed reduction mechanism 6 is a parallel axes single reduction mechanism and is made up of a drive gear 61 and a driven gear 62, and a helical gear is made up by both the gears 61, 62. In addition, the drive gear 61 and the driven gear 62 are housed in the interior of a gear housing 15 in such a state that the gears mesh with each other.

The gear housing 15 is made of a light metal such as an aluminum alloy or a diecast metal of cast iron and has in the interior thereof a drive gear housing portion 151 which houses the drive gear 61, a driven gear housing portion 152 which houses the driven gear 62 and a cylindrical mounting portion 153 in which the electric motor 5 is mounted, and the electric motor 5 is mounted in the mounting portion 153 in such a state that a rotation shaft 5a of the electric motor 5 is in parallel with the steering shaft 2.

The drive gear 61 is such as to have a toothed portion 61a on an outer circumference of an axially middle portion and shaft portions 61b, 61c at ends thereof and is rotatably supported within the drive gear housing portion 151 via bearings 16, 17 which are provided at the shaft portions 61b, 61c, respectively. One of the shaft portions 61b is connected coaxially to the rotation shaft 5a of the electric motor 5 by means of a tubular element 18 or the like.

The bearings 16, 17 are securely fitted in an inner circumference of the drive gear housing portion 151 by press fit, respectively. A presser ring 22 with a nut 21 is provided on an axially outer side of the bearing 16 on the side of the electric motor 5, and an axial preload is applied to the drive gear 61 via the presser ring 22 and the bearing 16 with which the presser ring 22 is brought into abutment.

The construction of the driven gear 62 will be described in detail by reference to FIGS. 2 and 3.

The driven gear 62 is configured so as to include a gear body 63 and two ring elements 64 which are mounted on the gear body 63.

The gear body 63 has at a rotational center thereof a through hole 65 through which the output shaft 12 is passed and has on an outer circumference thereof a toothed portion 66 which meshes with the toothed portion 61a of the drive gear 61. The gear body 63 also has on a diametrically inner side of the toothed portion 66 a disc portion 67 which is thinned in the axial direction. Two annular grooves 68 are formed along axial opposite sides of the disc portion 67 and in a diametrically inner circumferential surface of the toothed portion 66 in such a manner as to be made to open towards the diametrically inner side.

The two ring elements 64 are provided in such a state that diametrically outer sides of the two ring elements 64 are fitted individually in the two annular grooves 68, while diametrically inner sides thereof are exposed on the opposite sides of the disc portion 67. The two ring elements 64 are fitted in the two annular grooves 68, respectively, with a loose interference or a transition fit in such a manner as to slide circumferentially (in directions indicated by arrows A) in the respective annular grooves and on the respective sides of the disc portion 67. In addition, the gear body 63 is made of steel or resin, and the ring elements are made of steel.

Note that the driven gear 62 is fixed to the output shaft 12 in such a manner as to prohibit a relative rotation thereto by inserting fastening devices (not shown) into two grooves 69 which are provided in a diametrical direction at diametrically inner side portions on a side of the gear body and in a bore in the output shaft 12.

According to the electric power steering system that is configured as has been described heretofore, in case teeth striking and meshing slide occur between the drive gear 61 and the driven gear 62, the ring elements 64 slide relative to the gear body 63 so as to attenuate the vibration of the gear body 63. This is because the ring elements 64 vibrate in a different phase from that of the gear body 63 due to impact generated when the teeth striking and meshing slide occur, whereby the vibration of the gear body 63 is cancelled by virtue of the difference in phase. Additionally, the attenuation of vibrations is attained due to a friction that is generated between the ring elements 64 and the gear body 63 absorbing the vibration energy of the gear body 63. As a results the gear teeth striking noise and meshing slide noise between the drive gear 61 and the driven gear 62 are reduced, so that noise that is generated at the time of steering the steering wheel is suppressed, thereby making it possible to realize quietness in the passenger compartment.

In addition, since the two ring elements 64 are provided on the axial opposite sides of the gear body 63, a good weight balance is attained between the axial sides of the gear body 63, whereby the rotation of the driven gear 62 is stabilized. Incidentally, the ring element 64 may be arranged only at one of the axial sides of the gear body 63. A configuration may be adopted in which the width dimension of the annular groove 68 is made larger than the thickness dimension of the ring element 64, so that the ring element 64 also slides axially relative to the gear body 63 when the steering member 1 is steered. The shape of the ring element 64 is not limited to a truly circular shape but may be of, for example, a polygonal ring shape or of a C-shape which results by opening partly the circular or ring shape, provided that the ring elements 64 are capable of sliding relative to the gear body 63. In the case of the C-shape, the ring element may be deformed to reduce the diameter so as to easily fit in an annular groove which is deep in a diametrical direction. The ring element 64 may be provided only on either of the axial sides of the gear body 63. The ring element 64 may be mounted on the rear main body 63 in such a manner as to slide relative thereto by inserting a machine screw or a pin in an elongated hole formed in the ring element 64 in such a manner as to extend circumferentially.

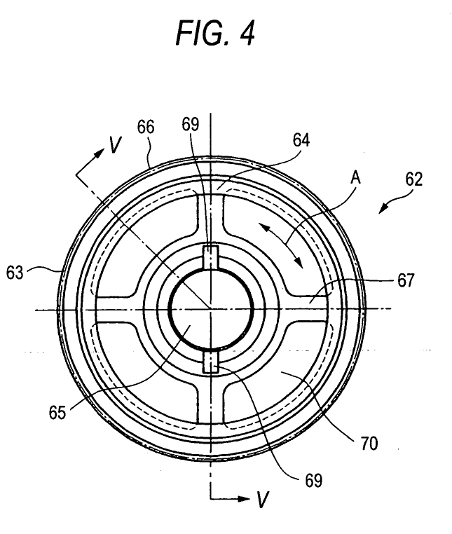

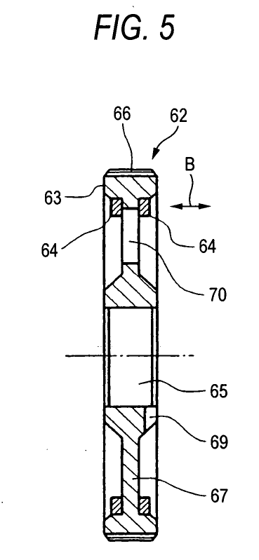

A second embodiment of the invention will be described by reference to FIGS. 4 and 5. FIG. 4 is a front view of a driven gear, and FIG. 5 is a sectional view taken along the line V-V in FIG. 4. In this second embodiment, configurations other than a driven gear remain the same as those of the first embodiment, In a driven gear 62 of the second embodiment, two ring elements 64 are fitted respectively in two sides of a disc portion 67 of a gear body 63 in such a manner as to slide in a circumferential direction (indicated by arrows A) and in an axial direction (indicated by arrows B). A cavity 70 is formed in the disc portion 67 of the gear body 63 in such a manner as to penetrate through the disc portion 67.

Also in the electric power steering system that is configured as has been described just above, since the ring elements 64 slide not only circumferentially but also axially, the vibration of the gear body 63 can be attenuated further, thereby making it possible to suppress the noise concerned. In addition, since the cavity 70 is formed in the gear body 63, the reduction in weight of the gear body 63 can be realized, and as a result, the inertia of the driven gear can be reduced.

The ring elements 64 may be fitted in annular grooves formed so as to be made to open towards a diametrically inner side of the gear body 63 on axial opposite sides of the disc portion 67 of the gear body 63 in such a manner as to slide relative thereto.

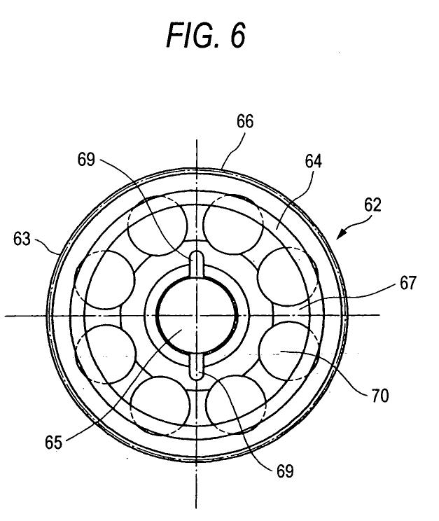

There is no limitation on the shape of the cavity 70, and hence, for example, a plurality of cavities 70 may, as shown in FIG. 6, be provided circumferentially at equal intervals to form a circular shape as a whole.

What is claimed is:

1. An electric power steering system which assists in steering by driving an electric motor in accordance with an operation of a steering member, comprising:
a drive gear connected to a rotation shaft of the electric motor; and
a driven gear securely fitted on a steering shaft so as to mesh with the drive gear;
wherein the driven gear includes a gear body and a ring element that is mounted on the gear body in such a manner as to slide relative to the gear body.

2. The electric power steering system according to claim 1, wherein the ring element is slidable in a circumferential direction of the gear body.

3. The electric power steering system according to claim 2, wherein the gear body is provided with an annular groove on which the ring element is arranged.

4. The electric power steering system according to claim 3, wherein the ring element is fitted to the annular groove by a transition fit.

5. The electric power steering system according to claim 1, wherein the ring element is slidable in an axial direction of the gear body.

6. The electric power steering system according to claim 1, wherein a pair of the ring elements are arranged at opposite sides of the gear body.

7. The electric power steering system according to claim 1, wherein the gear body is made of steel or resin, and the ring element is made of steel.

8. The electric power steering system according to claim 1, wherein the gear body is provided with a toothed portion at an outer circumference thereof.

9. The electric power steering system according to claim 1, wherein the ring element is arranged at one of axial sides of the gear body.
